(19) United States
(12) Patent Application Publication
(10) Pub. No.: US 2024/0056846 A1
(43) Pub. Date: Feb. 15, 2024

(54) LOAD BALANCING IN NEW RADIO

(71) Applicant: Apple Inc., Cupertino, CA (US)

(72) Inventors: Haitong Sun, Cupertino, CA (US); Dawei Zhang, Saratoga, CA (US); Hong He, San Jose, CA (US); Huaning Niu, San Jose, CA (US); Jie Cui, San Jose, CA (US); Wei Zeng, Saratoga, CA (US); Xiang Chen, Campbell, CA (US); Yang Tang, San Jose, CA (US)

(73) Assignee: Apple Inc., Cupertino, CA (US)

(21) Appl. No.: 18/231,552

(22) Filed: Aug. 8, 2023

Related U.S. Application Data
(60) Provisional application No. 63/396,555, filed on Aug. 9, 2022.

(51) Int. Cl. H04W 24/08; H04W 8/22

(52) U.S. Cl. CPC H04W 24/08; H04W 8/22

(57) ABSTRACT

Techniques are directed toward measuring a synchronization signal block (SSB) outside an active bandwidth part (BWP). An example method includes a user equipment (UE) transmitting an indication of a capability to measure a synchronization signal block (SSB) outside of an active bandwidth part (BWP) to a base station. The method can further include the UE receiving, based on the transmission, a first configuration parameter for identifying a first BWP and a second BWP, a second configuration parameter for identifying the first BWP as an active BWP, and a third configuration parameter for identifying a frequency that is carrying the SSB. The method can further include the UE detecting the SSB in the second BWP and outside of the active BWP. The method can further include the UE measuring the SSB.

### CROSS-REFERENCE TO RELATED APPLICATIONS

This application is claims the benefit of U.S. Provisional Application No. 63/396,555, filed on Aug. 9, 2022, which is incorporated by reference.

### BACKGROUND

Cellular communications can be defined in various standards to enable communications between a user equipment and a cellular network. For example, Fifth generation mobile network (5G) is a wireless standard that aims to improve upon data transmission speed, reliability, availability, and more.

### BRIEF DESCRIPTION OF THE DRAWINGS

FIG. 1 is an illustration of a system for using a bandwidth part (BWP) for uplink (UL) and downlink (DL) allocation, according to one or more embodiments.

FIG. 2 is an illustration of a user equipment (UE) configured to measure a cell-defining synchronization block (CD-SSB) outside of an active BWP, according to one or more embodiments.

FIG. 3 is an illustration of scheduling restrictions during a layer (L1) measurement of an SSB, according to one or more embodiments.

FIG. 4 is an illustration for configuring a non-cell defining (NCD) SSB, according to one or more embodiments.

FIG. 5 is an illustration of a definition of an NCD-SSB, according to one or more embodiments.

FIG. 6 is an illustration of an information element (IE) provided via a radio link monitoring resource set, according to one or more embodiments.

FIG. 7 is an illustration of an IE provided via a CSI-SSB-resource set, according to one or more embodiments.

FIG. 8 is a process flow for SSB measurement outside of an active band, according to one or more embodiments.

FIG. 9 is a process flow for SSB measurement outside of an active band, according to one or more embodiments.

FIG. 10 is a process flow for SSB measurement outside of an active band, according to one or more embodiments.

FIG. 11 illustrates an example of receive components, in accordance with some embodiments.

FIG. 12 illustrates an example of a UE, in accordance with some embodiments.

FIG. 13 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Cellular networks continue to seek to improve efficiency for spectrum usage and application usage. As the number of user equipment (UEs) and overall user demand increases, networks can apply various techniques for improving the network's performance through spectrum management, transmission latency, and resource management. The number in the increase of applications corresponds to an increase in user demand for data. This increased demand can introduce stress into the uplink (UL) and downlink (DL) transmission performance.

A method for improving data rates and power consumption for UL and DL transmissions is through a load balancing technique in which a base station can divide a channel bandwidth into bandwidth parts (BWPs). The base station can subdivide a carrier into BWPs, where each BWP can be a contiguous set of physical resource blocks (PRBs), selected from a contiguous subset of the common resource blocks for a given numerology (μ) on a given carrier. Each BWP can include its own numerology, such that each BWP of the carrier can be configured with different signal characteristics. For example, one BWP can have reduced power requirements, whereas another BWP can be for supported another service. The base station can further configure a UE with up to four BWPs for UL transmissions and up to four BWPs for DL transmissions. However, only one BWP can be active for UL transmissions and one BWP can be active for DL transmissions at any given time. The BWPs enable the UE to operate within a narrow bandwidth, which can reduce power consumption while continuing to have acceptable data rates.

Embodiments of the present disclosure are described in connection with 5G networks. However, the embodiments are not limited as such and similarly apply to other types of communication networks including other types of cellular networks.

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

The term “Non-3GPP Access” refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC), whereas untrusted non-3GPP accesses interwork with the EPC/5GC via a network entity, such as an Evolved Packet Data Gateway and/or a 5G NR gateway. In general, non-3GPP access refers to various types of non-cellular access technologies.

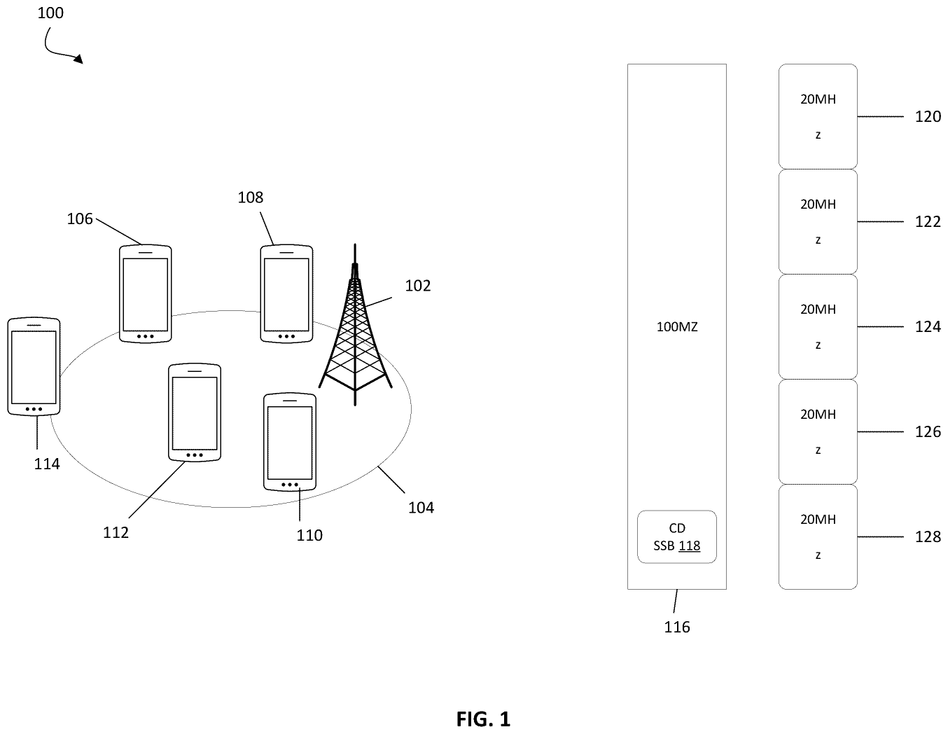

FIG. 1 is an illustration of a system for BWP allocation for uplink (UL) and downlink (DL), according to one or more embodiments. A base station 102 can be situated in a geographical area (e.g., cell) 04 and provide service for a cellular network. As described herein, the base station 102 can conform to various technical standards, such as a 4G eNB, a 5G gNB, a 6G base station, or a non-3GPP wireless node (e.g., radar or satellite, etc.). Multiple UE's can receive service provided by the base station 102. As illustrated, a first UE 106, a second UE 108, a third UE 110, a fourth UE 112, and a fifth UE 114 can receive service provided by the base station 102.

In one scenario, the base station 102 can configure a UE (e.g., the first UE 106, the second UE 108, the third UE 110, the fourth UE 112, or the fifth UE 114) with an initial channel bandwidth (e.g., 100 MHz) 116, which can provide a strong experience, for example, for high resolution video consumption. This user experience can be coupled with high power consumption. The base station 102 can further configure the channel bandwidth 116 to include a cell-defining-synchronization signal block (SSB) 118, which can include a primary synchronization signal (PSS) and the secondary synchronization signal (SSS) in consecutive symbols. The synchronization signals can be combined with a physical broadcast channel (PBCH) to form the CD-SSB 118. A UE can measure the CD-SSB 118 to acquire time and frequency synchronization with the cell and detect the physical layer ID (PCI) of the cell. The CD-SSB 118 can further be associated with system information block #1 (SIB1) that has the new radio cell global identifier (NGCI) of the cell. A non-cell defining-SSB (NCD-SSB) is not associated with the SIB 1.

In some instances, the base station 102 may want to load balance among UEs that require power saving (e.g., operate within a smaller active BWP). The base station 102 would prefer to subdivide the channel bandwidth 116 into smaller BWPs (e.g., a first BWP 120, a second BWP 122, a third BWP 124, a fourth BWP 126, and a fifth BWP 128). Each of the smaller BWPs can correspond to an independent frequency range, where each independent frequency range corresponds to a portion of the frequency range of the channel bandwidth 116. As illustrated, each of the smaller BWPs correspond to a 20 MHz BWP. These smaller BWPs can be associated with less power consumption for UL and DL transmissions than the larger channel bandwidth 112. For many applications, a 20 MHz is sufficient, and therefore the user can still have a good experience using these applications over the smaller BWP. As illustrated, the base station 102 can configure the first UE 106 with up to four BWPs from the first BWP 120, the second BWP 122, the third BWP 124, the fourth BWP 126, and the fifth BWP 128. As further illustrated, a CD-SSB 118 can correspond to the fifth BWP 128, whereas the other four smaller BWPs would not correspond to the CD-SSB 118.

One issue that can arise is that the cell-defining synchronization signal block (CD-SSB) 118 is transmitted over one of the smaller BWPs, and that smaller BWP is not the active BWP. Therefore, the UE would need to measure the CD-SSB outside of its own active BWP. For example, as illustrated, the CD-SSB 118 is transmitted over the fifth BWP 128. Therefore, if a UE's active BWP was any one of the first BWP 120 through the fourth BWP 126, the CD-SSB 118 would be transmitted on a BWP outside of the active BWP.

A UE can be configured to perform measurements on the SSB or on a channel state information reference signal (CSI-RS). However, measurement of the CSI-RS may not be supported by some vendors. However, these vendors, and the vendors whose UEs support CSI-RS measurement, do configure their UEs to perform reference signal measurement of the SSB. For SSB measurement, the UE can be configured for multiple types of measurement. For a layer 3 (L3) radio resource management measurement (RRM), a base station can configure the UE with a measurement object (MeasObjectNR) that specifies what is to be measured. For a layer 1 (L1) radio link monitoring (RLM), a base station 102 can configure the RLM reference signal (RLMRs, RadioLinkMonitoringRS) to permit a UE to perform RLM (e.g., of a primary serving cell (Pcell)). For L1 beam failure detection (BFD), the base station 102 can configure the RLMRS to permit the UE to measure BFD. For L1 reference signal received power (L1-RSRP) or L1 signal to interference noise ratio (L1-SINR), the base station can configure the channel state information report (e.g., CSI reference signal (CSI-RS)) to permit the UE to perform either of these measurements. Currently, for L3 measurement of the SSB, a base station can configure the UE to measure the SSB outside of its active BWP. The measurements can be performed with measurement gaps, wherein the UE has measurement gaps where it does not take measurements of a target carrier frequency while simultaneously transmitting or receiving. The measurement can also be taken without measurement gaps where the UE is configured with multiple radio frequency (RF) chains. This is unlike the L1 measurement, in which the UE is not required to L1 measurement such as RLM, or BFD, or L1-RSRP, or L1-SINR outside the active DL BWP.

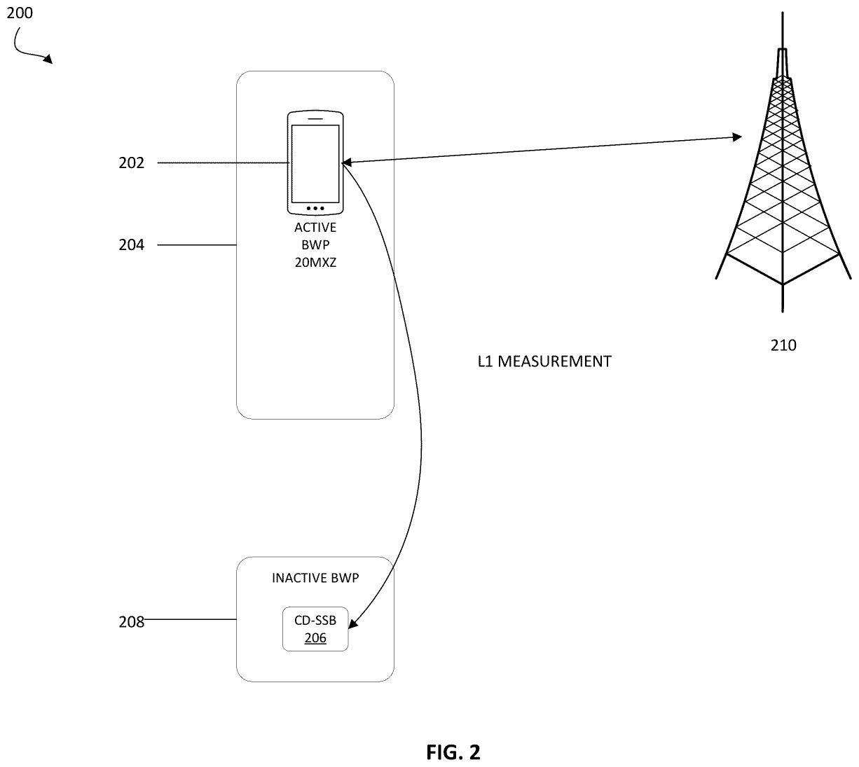

Embodiments described herein provide a methodology for a UE to perform an L1 measurement of a CD-SSB that is transmitted over a BWP that is outside of the UE's active BWP. The embodiments also address the issues above by configuring a non-cell-defining (NCD) SSB 3GPP TS 38.331. FIG. 2 is an illustration 200 of a UE configured to measure a CD-SSB outside of an active BWP, according to one or more embodiments. As illustrated, a UE 202 operating over an active BWP 204 (e.g., initial BWP) can measure a CD-SSB 206 that is transmitted outside an active BWP 208 (e.g., first BWP). It should be appreciated that although the active BWP is indicated as 20 MHz, this is for illustration purposes only, and the active BWP 208 can include different frequency ranges. The UE 202 can have the capability to measure a CD-SSB outside of an active BWP (including measuring RLM, BFD, L-RSRP, L1-SINR). However, a base station 210 can be unaware that the UE 202 has the capability, as it is prohibited by the current standards. Furthermore, a base station should not assume that no UE has this capability or that all UEs have this capability. Therefore, in some embodiments, the UE 303 can report this capability to the base station 210, if the UE conforms to the 3GPP release 17 standards or the 3GPP release 18 standards. Under these embodiments UE's that conform to #3GPP release 16 or earlier could not support this functionality. This is partially due to issues of reconfiguring release 16 and earlier UEs to be compatible with this capability. In other embodiments, the UE 202, if conforming with 3GPP release 16 standard, can report supporting this capability.

The UE 202 can have flexibility as to reporting the capability to perform L1 measurement of a CD-SSB 206 outside of an active BWP 204 (including RLM, BFD, L1-RSRP, L1-SINR) to the base station 210. In some embodiments, the UE 202 can report the capability to the base station 210 based on the band. In other embodiments, the UE 202 can report the capability to the base station 210 based on the band in a particular bandwidth combination (BC). The UE 202 can support multiple band combinations (BCs) for carrier aggregation (CA). Therefore, the UE can send a report as to whether the capability is available based on each band in a supported BC. For example, a first BC can include band 1, band 2, and band 3, and a second BC can include band 1, band 4, and band 5, such that both BCs include band 1. In this embodiment, the UE 202 can report that it can support the capability for band 1 in the first BC. The UE 202 can additionally report that it does not support this capability for band 2 in the second BC. This is different than the previous embodiment, in which the UE 202 reports the capability per band. In other embodiments, the UE 202 can report the capability on a per UE basis, where the UE reports the ability interpedently for the frequency range 1 (FR1), where FR1 can generally describe bands in the sub 6 GHz spectrum. The UE 202 can also report the capability interpedently for the frequency range 2 (FR2), where FR2 can describe bands in the millimeter (mmWave) spectrum. The reporting can be performed during a radio resource control (RRC) configuration between the base station 201 and the UE 202, where the base station 210 can ask the UE 202 for its capabilities.

As described above, for an L1 measurement of SSB, the UE 202 can be configured to perform various types of measurements. The UE 202 can be configured to have the capability to support one or more of these measurement types. In one embodiment, the UE 202 can be configured to have a single capability that supports measurement types of RLM, BFD, L1-RSRP, and L1-SINR. In another embodiment, the UE 202 can be configured to include more than one capability to separate the measurement types RLM, BFD, L1-RSRP, and L1-SINR. For example, the UE 202 can be configured to have a first capability for RLM and BFD, a second capability for L-RSRP, and a third capability for L1-SINR.

As indicated above, the UE 202 can support an L1 measurement of an SSB outside an active BWP, and in particular the UE can take a BFD measurement for a primary cell (SpCell) and a secondary cell (SCell). An SpCell can be a special cell including a primary cell (PCell) and a primary secondary cell (PSCell). The PCell can be the primary cell in the master cell group (MSG). The PSCell can be the primary cell for the secondary cell group (SCG). For the SpCell, the UE 202 can support SpCell BFD measurements on the SSB outside of the active BWP (e.g., inactive BWP 208). The UE 202 can initiate a BFD session with a node of the SpCell and detect a beam failure based on detecting hypothetical physical downlink control channel block error rate (PDCCH BLER) above a threshold. If a failure is detected at the SpCell, then it is unlikely that the UE 202 receives service. The UE 202 can support SpCell BFD measurements on the SSB outside of the active BWP, if the UE 202 support this capability.

As to a SCell, in some embodiments, the UE 202 is not expected to support SCell BFD measurements on the SSB outside the active BWP. An SCell is a secondary cell that operates together with the primary cell, which can provide the UE 202 with additional resources. In other embodiments, the UE 202 can be expected to support SCell BFD measurements on a SSB outside the active BWP if (1) the UE supports the capability, and (2) the UE supports feature group (FG) 2-31(e.g., maxNumberSCELLBFR-r16).

With regards to L1-SINR type measurement, the UE 202 can support the L1 measurement of the SSB outside the active BWP in some instances, and not support this capability in other instances. Measurement of L1-SINR is a relatively new feature that was introduced in 3GPP release 16. In some embodiments, the UE 202 can be configured not to support taking a L1-SINR measurement outside the active BWP. In other embodiments, the UE can be configured to take L1-SINR measurements outside the active BWP, if (1) the UE 202 supports the capability, and (2) the UE 202 supports FG 16-1a-1 (e.g., ssb-csirs-SINR-measurement-r16).

If the UE 202 supports taking L1-SINR measurements, the L1-SINR measurements can be taken using a channel measurement resource (CMR) and using interference measurement resource (IMR). If the UE 202 supports using CMR, the base station 210 can configure the CMR to permit the UE 202 to measure the SSB outside the active BWP 204. If, however, the UE 202 supports using IMR, in some instances, the UE 202 is not expected to measure the L1-SINR using the IMR outside the active BWP 204. This is because the base station 210 does not configure the IMR to permit the UE 202 to measure the SSB outside of the active BWP 204. In other instances, the UE 202 can be expected to support the measurement of the SSB outside of the active BWP 204. In these instances, the base station 210 can configure the IMR to permit the UE 202 to measure the SSB outside of the active BWP 204 subject to the UE 202 having additional capability. In yet another embodiment, the UE 202 can be required to support measuring the BWP without restriction. This embodiment can be effectuated, if the UE 202 supports FG 6-1a, wherein the BWP does not include an SSB (see, for example, 3GPP TS 38.306). BWP without restriction, where the bandwidth restriction in terms of DL BWP for PCell and PSCell, can mean that the bandwidth of a UE-specific RRC configured DL BWP may not include the bandwidth of control resource set (CORESET #0) (if configured) and SSB. Additionally, for an SCell, the restriction can mean that the bandwidth of DL BWP may not include SSB.

In some embodiments, the UE 202 can be required to report, to the base station 210, the ability to take L1 measurement on the SSB outside of the active BWP 204, when certain conditions are met. The first condition can be that the UE 202 can support BWP without restriction (e.g., as described by FG6-1a, bwp-WithoutRestriction). The second condition can be that the UE 202 does not support one or more of the following features: (1) cell specific-reference signal (CS-RS) based measurement of RLM (e.g., FG 1-7, csi-RS-RLM); (2) CS-RS based measurement of primary cell BFD (e.g., FG 2-31, maxNumberCSl-RS-BFD); or (3) CSI-RS based measurement of L1-RSRP.

The base station 210 can configure multiple BWPs (include greater than four BWPs). Therefore, the SSB needs to be in one of the up to four BWPs that the base station 210 configured with the UE 202. Otherwise, the UE 202 cannot measure the SSB regardless of whether the SSB is in the active BWP or inactive BWP. Therefore, in some embodiments, the base station 210 is required to configure the BWPs such that the SSB is included in at least one BWP configured with the UE 202. In some other embodiments, the SSB has to be contained within a DL bandwidth of the serving cell. For example, the SSB can be configured in the DownlinkConfigCommonSIB which provides common downlink parameters of the serving cell. The SSB can also be configured in the DownlinkConfigCommon, which provides common downlink parameters of the serving cell. In yet another embodiment, there is no restriction on the frequency location of the SSB. However, with this embodiment, there is no guarantee that the SSB will be located with a BWP that has been configured with the UE 202.

In the instance that the base station 210 configures the UE 202 to perform L1 measurement on the SSB outside of the active BWP 204, in some embodiments, the SSB has to be a CD-SSB, and in other embodiments, the SSB can be either a CD-SSB or an NCD-SSB.

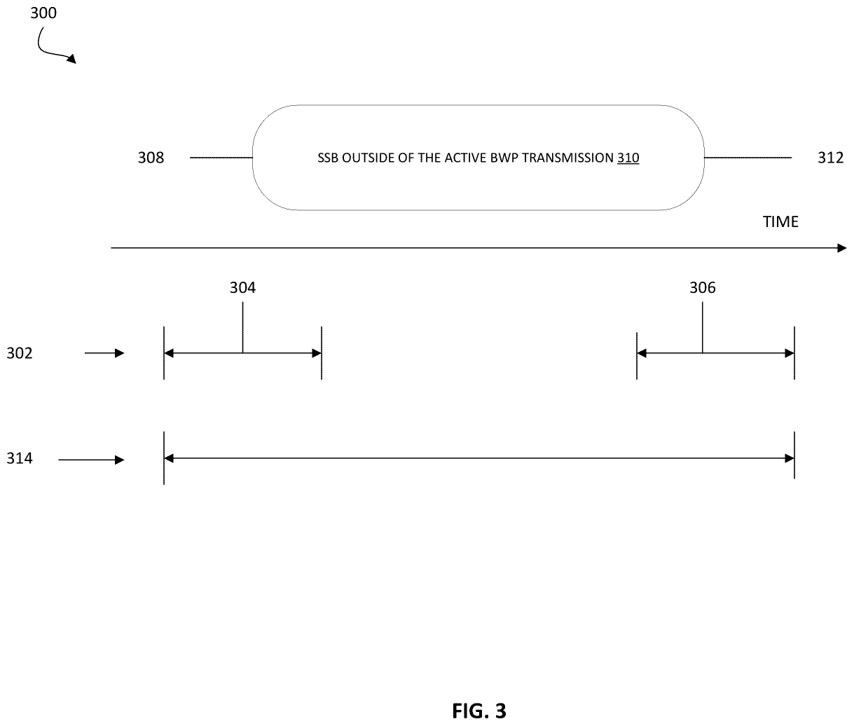

FIG. 3 is an illustration 300 of scheduling restrictions during an L1 measurement of an SSB, according to one or more embodiments. As indicated above, a base station can configure a UE to take a L1 measurement of an SSB. To accomplish this, the UE has to tune the antenna away from scheduled UL and DL transmissions and to the frequency of the SSB. Once the UE takes the measurement, the UE can retune the antenna to continue performing scheduled UL and DL transmissions. Each time that the UE tunes away from the frequencies of the scheduled UL and DL transmissions, there is an interruption of service. Therefore, scheduling restrictions can be implemented to limit the impact of the measurements.

In a first embodiment, a first scheduling restriction 302 can be defined as including a first time duration 304 and a second time duration 306, wherein no scheduled UL or DL transmission occur. The first time duration 304 can correspond to the beginning 308 of an SSB outside of the active BWP 310. The second time duration 306 can occur at the end 312 of the SSB outside of the active BWP transmission 310. For this first scheduling transmission, a base station can configure the UE to expand the BWP to include the active BWP and the inactive BWP that includes the SSB. For example, referring to FIG. 1, the active BWP can be the fifth BWP 128 and the inactive BWP that includes the SSB can be the fifth BWP 128. The base station 102 can configure a UE with a BWP that includes the fifth BWP 128 and the fifth BWP 128. The UE can tune its antenna to the frequencies of both the first BWP 120 and the fifth BWP 128 during the first time duration 304. The UE can tune its antenna back to just the frequency of the fifth BWP 128 during the second time duration 306. Therefore, the UE can continue with scheduled UL and DL transmissions over the fifth BWP 128, except during the tuning occurring at the first time duration 304 and the second time duration 306.

In another embodiment, a third time duration 314 can span from the beginning 308 of an SSB outside of the active BWP transmission 310 to the end 312 of the SSB outside of the active BWP transmission 310. During the third time duration 314, the UE does not perform any scheduled UL and DL transmission. In particular, in some embodiments, during the time durations, the UE is not capable of performing DL control monitoring, DL data reception, and DL measurement, and UL transmission.

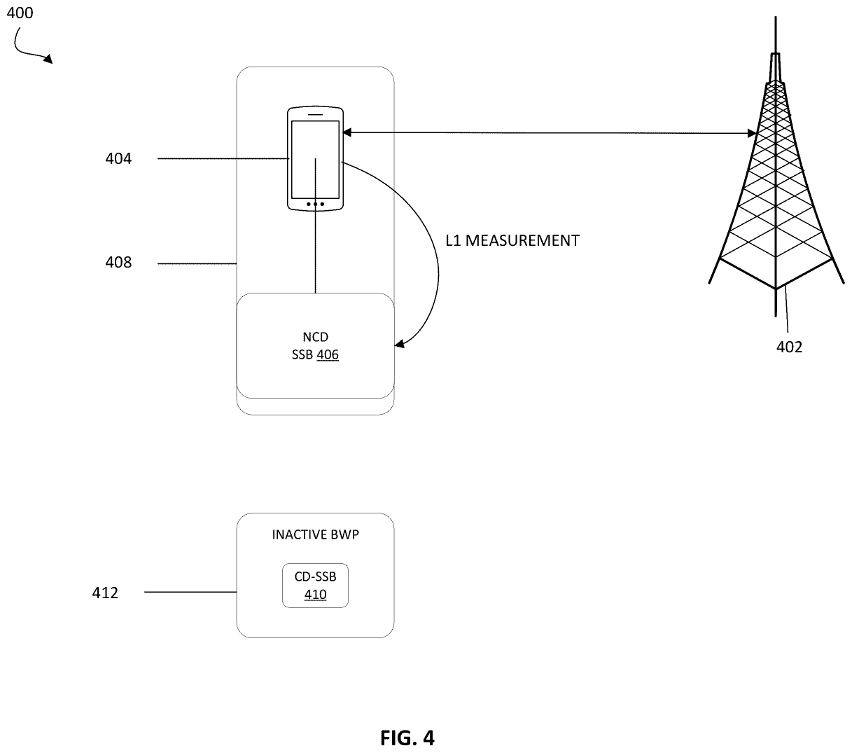

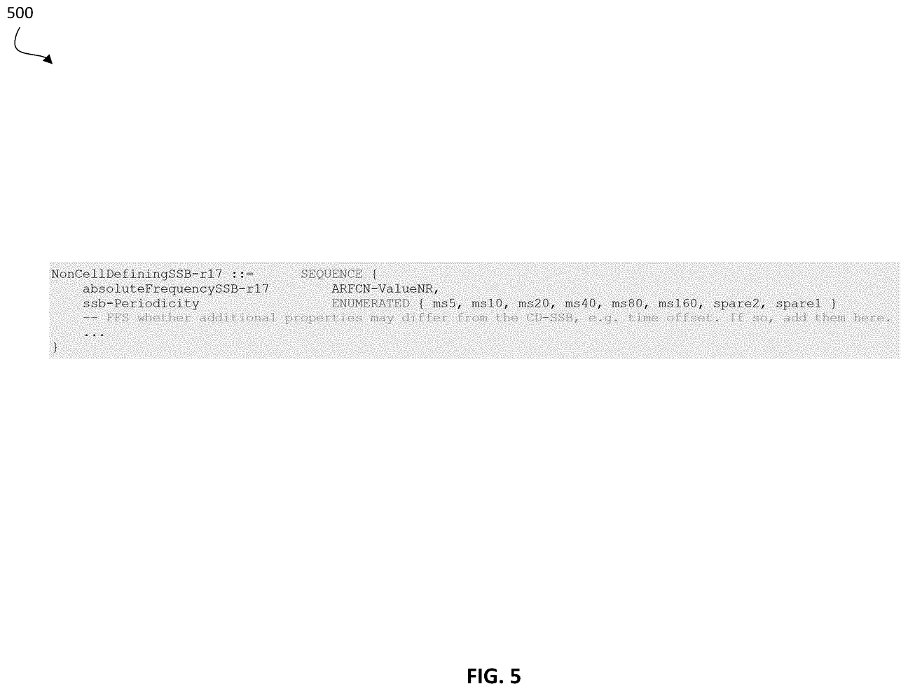

FIG. 4 is an illustration 400 for configuring an NCD-SSB, according to one or more embodiments. A base station 402 can configure an NCD-SSB for a non-reduced capability (non-RedCap) UE 406, where a RedCap device can be configured to have reduced capabilities that include less peak throughput, longer latency, less reliability, more power consumption efficiency, less system overhead, or less resource costs. In some embodiments, the non-RedCap UE 406 can be configured to support a new capability for supporting an LI measurement of an NCD-SSB. This capability is supported for RedCap devices and can be extended to non-RedCap devices. As illustrated, the NCD-SSB 406 can be transmitted in the active BWP 408. Therefore, the non-RedCap UE 404 can take the measurement of the NCD-SSB 406 within the active band. In another embodiment, the non-RedCap UE 404 can be mandated to support measurement of the NCD-SSB 406. FIG. 5 is an illustration of a definition 500 of a NCD-SSB, according to one or more embodiments.

If this capability is added, the base station 402 can be unaware that the non-RedCap UE 404 has the capability. Therefore, in some embodiments, the non-RedCap UE 404 can report this capability to the base station 402 if the non-RedCap UE 404 conforms to the 3GPP release 17 standards or the 3GPP release 18 standards. Under these embodiments, a non-RedCap UE 404's that conforms to #3GPP release 16 or earlier could not support this functionality. In other embodiments, the non-RedCap UE 404, if conforming with 3GPP release 16 standards or higher, can report supporting this capability.

The non-RedCap UE 404 can have flexibility as to reporting the capability to perform L1 measurement of a NCD-SSB 406 to the base station 402. In some embodiments, the non-RedCap UE 404 can report the capability to the base station 210 based on the band. For example, the non-RedCap UE 404 can be configured to measure the NCD-SSB 406 by the base station 210. In other embodiments, the non-RedCap UE 404 can report the capability to the base station 210 based on the per band per BC. The non-RedCap UE 404 can support multiple BCs for CA. Therefore, the UE can send a report as to whether the capability is available based on each band in a supported BC. In other embodiments, the UE can report the capability on a per UE basis, where the UE reports the ability independently for FR1. The UE 202 can also report the capability independently for FR2. The reporting can be performed during a radio resource control (RRC) configuration between the base station 402 and the non-RedCap UE 404, where the base station 402 can ask the non-RedCap UE 404 for its capabilities.

In the instance that the base station 402 configures the NCD-SSB 406 for the UE (e.g., non-RedCap UE 404) one or more restrictions on the non-RedCap UE 404 can be introduced. As illustrated, the base station 402 has also configured a CD-SSB 410 in an inactive BWP 412. A non-RedCap UE 404 could potentially measure the NCD-SSB 406, the CD-SSB 410, or both. In which case, the non-RedCap UE 404 does not know which SSB to rely upon. This could lead to an undesirable result as the base station 402 can have intended that the non-RedCap UE 404 only read one SSB. Therefore, one restriction can be that the non-RedCap UE 404 does not expect to be configured to measure an SSB that is outside of the active BWP 408.

It is conceivable that the base station 402 configured both the NCD-SSB 406 and the CD-SSB 410 in the same BWP, such as the active BWP 408. Again, in this situation non-RedCap UE 404 could potentially measure the NCD-SSB 406, the CD-SSB 410, or both. Therefore, another restriction can be that the non-RedCap UE 404 does not expect to be configured to measure more than one SSB within the same active BWP 408.

It should be appreciated that in some instances, a base station can configure more than one SSB to the non-RedCap UE. In this situation, the non-RedCap UE needs to be able to determine which SSB to measure. In some embodiments, the base station can transmit an additional information element (IE) can be introduced to indicate the SSB location (e.g., absolute frequency as described in 3GPP release 17 (absoluteFrequencySSB-r17 ARFCN-ValueNR)). The IE can guide the non-RedCap UE to resolve any ambiguity as to which SSB to measure. The absolute frequency of the SSB can be the frequency to be used for a serving cell. Furthermore, SSB related parameters (e.g., SSB index) can be provided for the serving cell to refer to this SSB frequency unless mentioned otherwise. The provided frequency in this field can identify the position of resource element RE #0 (subcarrier #0) of resource block RB #10 of the SS block. The cell-defining SSB of the PCell can be on the sync raster.

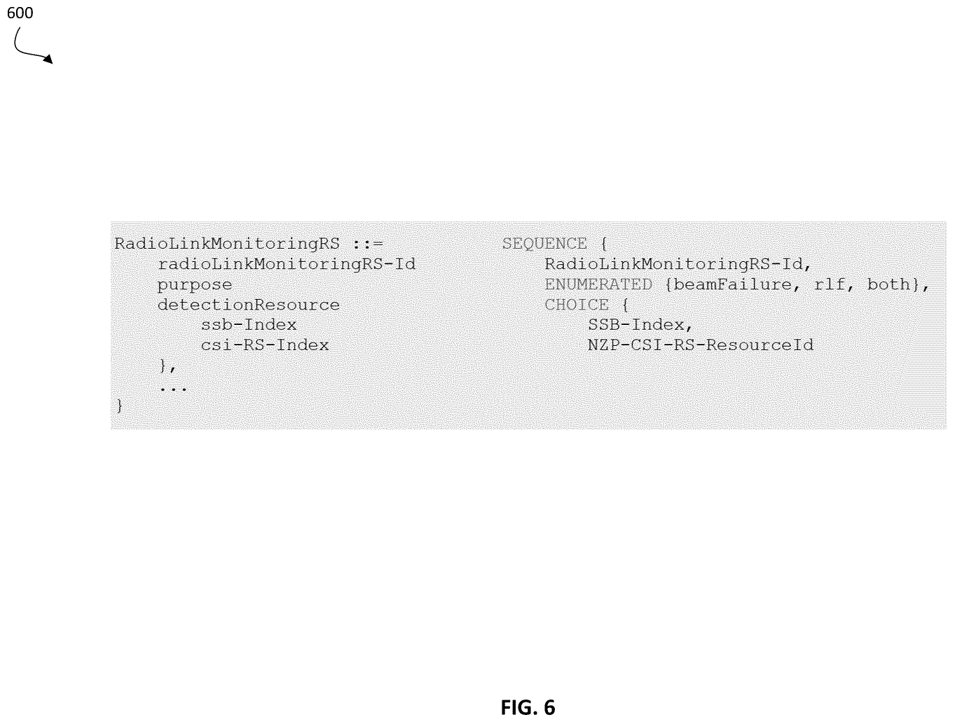

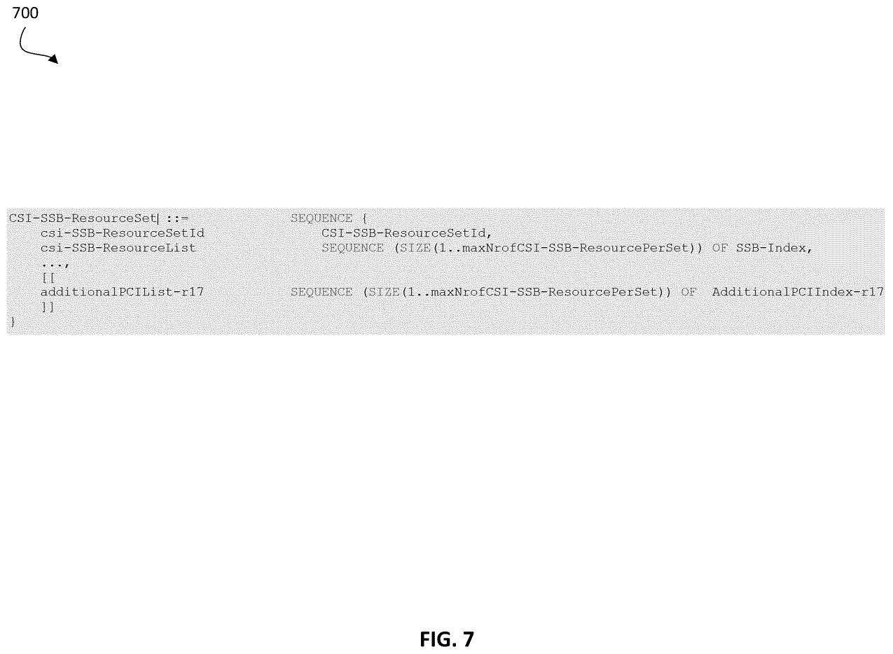

For RLM or BFD type measurements, the IE can be provided to the non-RedCap UE via a radio link monitoring resource set (RadioLinkMonitoringRS). Where radio link monitoring can be a reference signal that the non-RedCap UE can use for radio link monitoring. The IE can guide the non-RedCap UE resolve any ambiguity as to which SSB to measure. FIG. 6 is an illustration of an IE 600 provided via a radio link monitoring resource set, according to one or more embodiments. For L1-RSRP or L1-SINR measurements, the IE can be provided to the non-RedCap UE via a CSI-SSB-ResourceSet. The IE can guide the non-RedCap UE to resolve any ambiguity as to which SSB to measure. FIG. 7 is an illustration of an IE 700 provided via a CSI-SSB-ResourceSet, according to one or more embodiments.

In other embodiments, the non-RedCap UE can resolve any ambiguity as to which SSB to measure without an additional IE. Rather the non-RedCap UE can be configured with rules that the non-RedCap UE can use. In some embodiments, the non-RedCap UE can prioritize the CD-SSB over the NCD-SSB. In other words, in a situation in which the base station has configured both the CD-SSB and the NCD-SSB in the active BWP. For example, the non-RedCap UE can detect both SSBs. In response to detecting both SSBs, the non-RedCap UE retrieves the control instructions that include the rules for resolving the ambiguity. Based on the rules, the non-RedCap UE measures the CD-SSB rather than the NCD-SSB.

In other embodiments, the non-RedCap UE prioritizes the SSB within the active BWP over the SSB outside the BWP. For example, a base station can configure one of the CD-SSB and the NCD-SSB in the active BWP and the other outside the active BWP. The non-RedCap UE can detect both SSBs. In response to detecting both SSBs, the non-RedCap UE retrieves the control instructions that include the rules for resolving the ambiguity. Based on the rules, the non-RedCap UE measures the SSB that is in the active BWP rather than the SSB that is outside the active BWP.

In yet other embodiments, the non-RedCap UE prioritizes the SSB with the lower periodicity over the SSB with the higher periodicity. For example, a base station can configure both the SSBs in the active BWP, both SSBs outside the BWP, or one SSB in the active BWP and the other SSB outside the active BWP. The non-RedCap UE can detect both SSBs. In response to detecting both SSBs, the non-RedCap UE retrieves the control instructions that include the rules for resolving the ambiguity. Based on the rules, the non-RedCap UE measures the SSB with the lower periodicity rather than the SSB with the higher periodicity.

As indicated above, a base station can configure multiple SSBs in different frequency locations. As also indicated above, this situation can cause ambiguity for the non-RedCap UE as to which SSB to measure. Therefore, in some embodiments, the UE's performance requirements can be defined such that the UE only measures an SSB in one of the frequency locations. Therefore, regardless of whether the base station has configured both the SSBs in the active BWP, both SSBs outside the BWP, or one SSB in the active BWP and the other SSB outside the active BWP, the UE is only expected measure one of the SSBs.

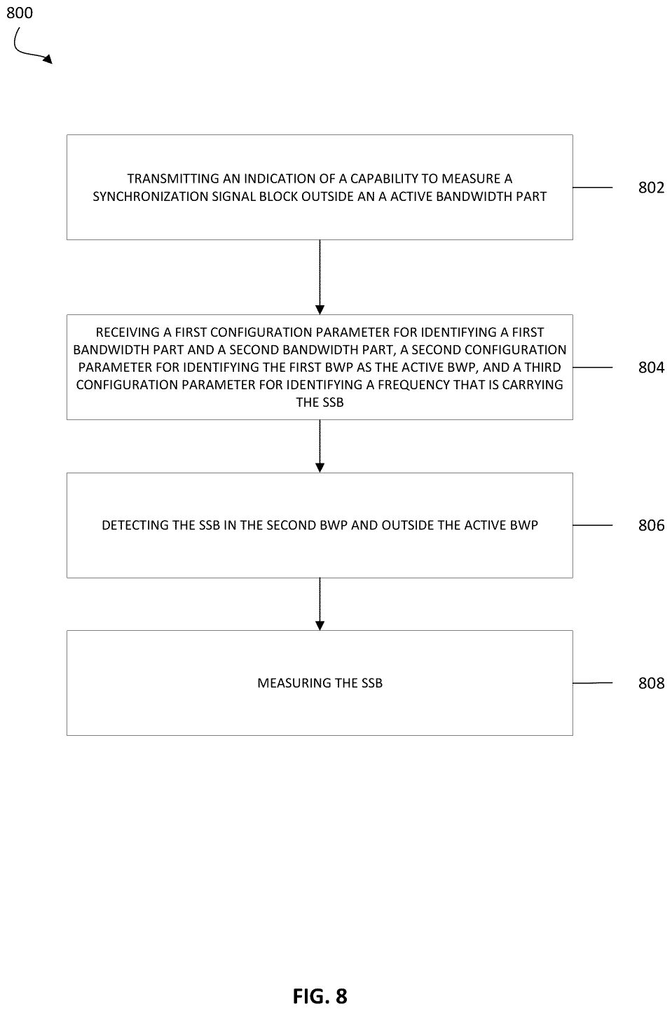

FIG. 8 is a process flow 800 for SSB measurement outside of an active band, according to one or more embodiments. At 802, the method can include a UE transmitting an indication of a capability to measure a synchronization signal block (SSB) outside of an active bandwidth part (BWP) to a base station. The indication can be transmitted during an RRC configuration and in response to a query by the base station.

At 804, the method can include the UE receiving, in response to the transmission, a first configuration parameter for identifying a first BWP and a second BWP, a second configuration parameter for identifying the first BWP as an active BWP, and a third configuration parameter for identifying the second BWP as carrying the SSB. The first BWP and the second BWP can be subdivisions of an initial BWP. By subdividing the initial BWP, the base station can help reduce power consumption by the UE.

At 806, the method can include the UE detecting the SSB in the second BWP and outside of the active BWP. The third configuration parameter can further include a frequency upon which the SSB is carried. The UE can use the frequency to locate the SSB and detect that the SSB is outside of the active BWP.

AT 808, the method can include the UE measuring the SSB outside the active BWP. The USE can use various measurement types to measure the SSB including, RLM, BFD, L1-RSRP, and L1-SINR.

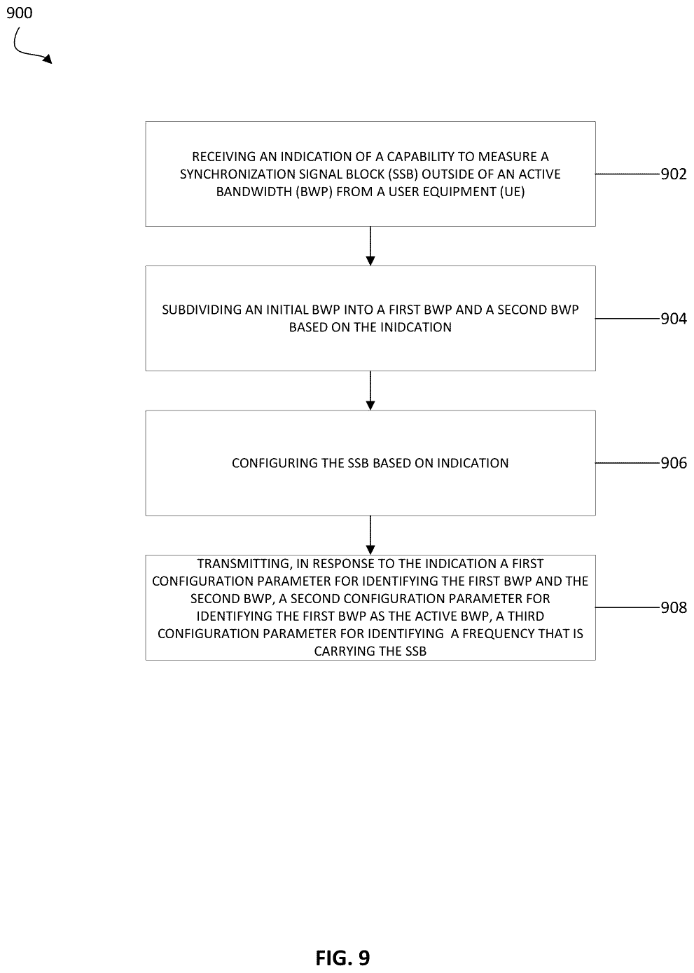

FIG. 9 is a process flow 900 for SSB measurement outside of an active band, according to one or more embodiments. At 902, the method can include a base station receiving an indication of a capability to measure an SSB outside of an active BWP from a UE. The indication can be received during an RRC configuration and in response to a base station query to the UE.

At 904, the method can include the base station subdividing an initial BWP into a first BWP and a second BWP based on the indication. Each BWP can be where each BWP can be a contiguous set of PRBs, selected from a contiguous subset of the common resource blocks for a given numerology (μ) on a given carrier.

At 906, the method can include the base station configuring the SSB based on the indication. This can include configuring a resource set to transmit the SSB.

At 908, the method can include the base station transmitting a first configuration parameter for identifying a first BWP and a second BWP, a second configuration parameter for identifying the first BWP as an active BWP, and a third configuration parameter for identifying the second BWP as carrying the SSB. The first BWP and the second BWP can be subdivisions of an initial BWP.

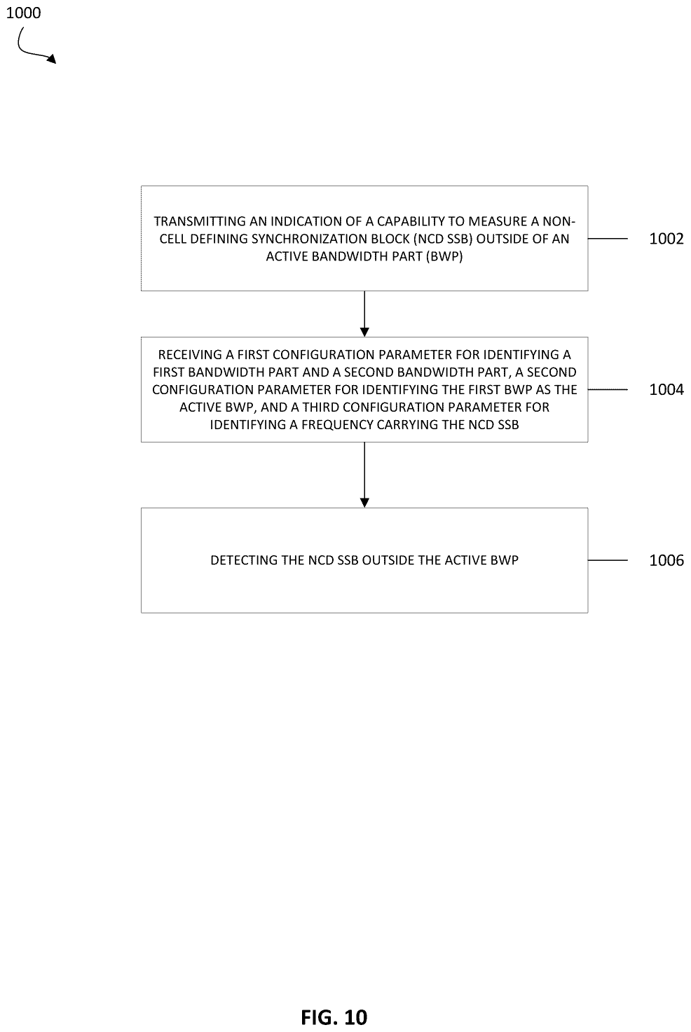

FIG. 10 is a process flow 1000 for SSB measurement outside of an active band, according to one or more embodiments. At 1002, the method can include a non-RedCap UE transmitting an indication of a capability to measure a synchronization signal block (SSB) outside of an active bandwidth part (BWP) to a base station. The indication can be transmitted during an RRC configuration and in response to a query by the base station.

At 1004, the method can include the UE receiving, in response to the transmission, a first configuration parameter for identifying a first BWP and a second BWP, a second configuration parameter for identifying the first BWP as an active BWP, and a third configuration parameter for identifying a frequency that is carrying the NCD-SSB. The first BWP and the second BWP can be subdivisions of an initial BWP. By subdividing the initial BWP, the base station can help reduce power consumption by the UE.

At 1006, the method can include the non-RedCap UE detecting the NCD-SSB in the second BWP and outside of the active BWP. The UE can use the frequency to locate the SSB and detect that the SSB is outside of the active BWP.

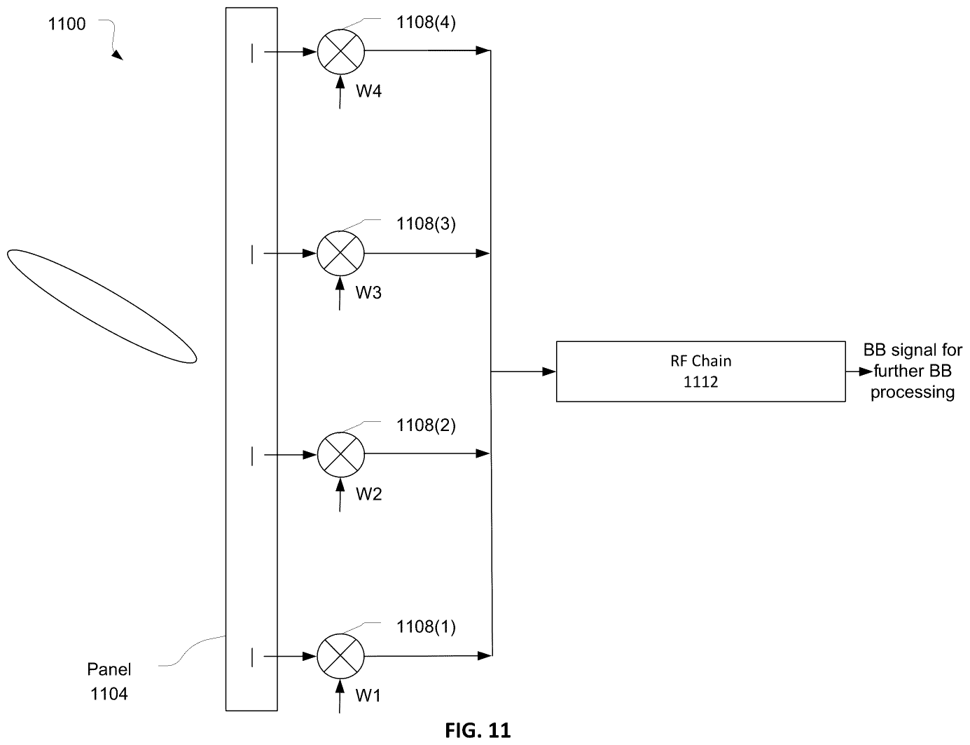

FIG. 11 illustrates receive components 1100 of the UE 116, in accordance with some embodiments. The receive components 1100 may include an antenna panel 1104 that includes a number of antenna elements. The panel 1104 is shown with four antenna elements, but other embodiments may include other numbers.

The antenna panel 1104 may be coupled to analog beamforming (BF) components that include a number of phase shifters 1108(1)-1108(4). The phase shifters 1108(1)-1108(4) may be coupled with a radio-frequency (RF) chain 1112. The RF chain 1112 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1108(1)-1108(4) to provide a receive beam at the antenna panel 1104. These BF weights may be determined based on the channel-based beamforming.

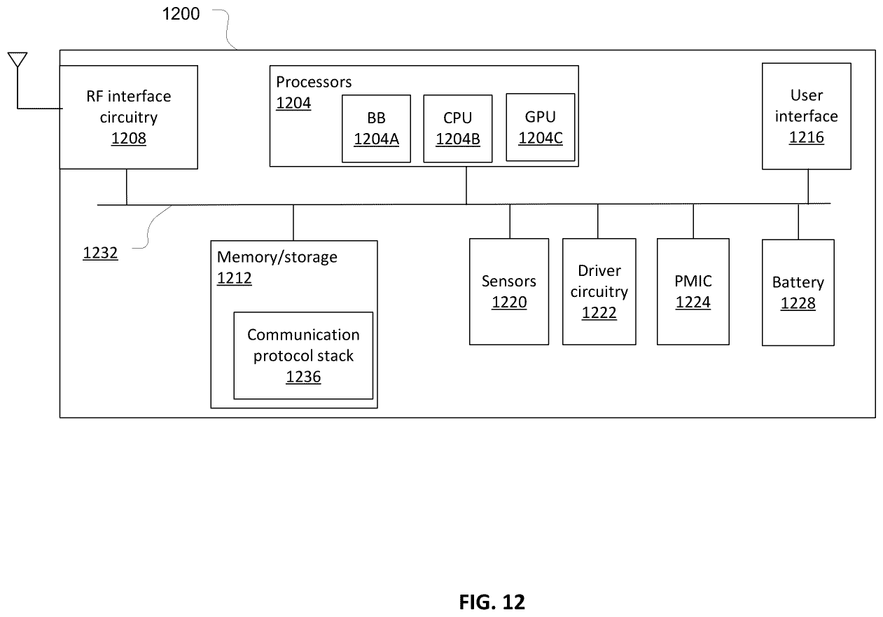

FIG. 12 illustrates a UE 1200, in accordance with some embodiments. The UE 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1200 may include processors 1204, RF interface circuitry 1208, memory/storage 1212, user interface 1216, sensors 1220, driver circuitry 1222, power management integrated circuit (PMIC) 1224, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangements of the components shown may occur in other implementations.

The components of the UE 1200 may be coupled with various other components over one or more interconnects 1232, which may represent any type of interface, input/output, bus (local, system, or expansion), transmission line, trace, optical connection, etc. that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform operations as described herein.

In some embodiments, the baseband processor circuitry 1204A may access a communication protocol stack 1236 in the memory/storage 1212 to communicate over a 3GPP compatible network. In general, the baseband processor circuitry 1204A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1204A may also access group information 1224 from memory/storage 1212 to determine search space groups in which a number of repetitions of a PDCCH may be transmitted.

The memory/storage 1212 may include any type of volatile or non-volatile memory that may be distributed throughout the UE 1200. In some embodiments, some of the memory/storage 1212 may be located on the processors 1204 themselves (for example, L1 and L2 cache), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and a radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1224 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1224.

In various embodiments, the RF interface circuitry 1208 may be configured to transmit/receive signals in a manner compatible with NR access technologies.

The antenna 1224 may include a number of antenna elements that each convert electrical signals into radio waves to travel through the air and to convert received radio waves into electrical signals. The antenna elements may be arranged into one or more antenna panels. The antenna 1224 may have antenna panels that are omnidirectional, directional, or a combination thereof to enable beamforming and multiple input, multiple output communications. The antenna 1224 may include microstrip antennas, printed antennas fabricated on the surface of one or more printed circuit boards, patch antennas, phased array antennas, etc. The antenna 1224 may have one or more panels designed for specific frequency bands including bands in FR1 or FR2.

The user interface circuitry 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1200.

The sensors 1220 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within, or connected to, the UE 1200. For example, driver circuitry 1222 may include a display driver to control and allow access to a display device, a touchscreen driver to control and allow access to a touchscreen interface, sensor drivers to obtain sensor readings of sensor circuitry 1220 and control and allow access to sensor circuitry 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

In some embodiments, the PMIC 1224 may control, or otherwise be part of, various power saving mechanisms of the UE 1200. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1200 may power down for brief intervals of time and thus save power. If there is no data traffic activity for an extended period of time, then the UE 1200 may transition off to an RRC Idle state, where it disconnects from the network and does not perform operations such as channel quality feedback, handover, etc. The UE 1200 goes into a very low power state and it performs paging where again it periodically wakes up to listen to the network and then powers down again. The UE 1200 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1228 may power the UE 1200, although in some examples the UE 1200 may be mounted deployed in a fixed location, and may have a power supply coupled to an electrical grid. The battery 1228 may be a lithium ion battery, a metal-air battery, such as a zinc-air battery, an aluminum-air battery, a lithium-air battery, and the like. In some implementations, such as in vehicle-based applications, the battery 1228 may be a typical lead-acid automotive battery.

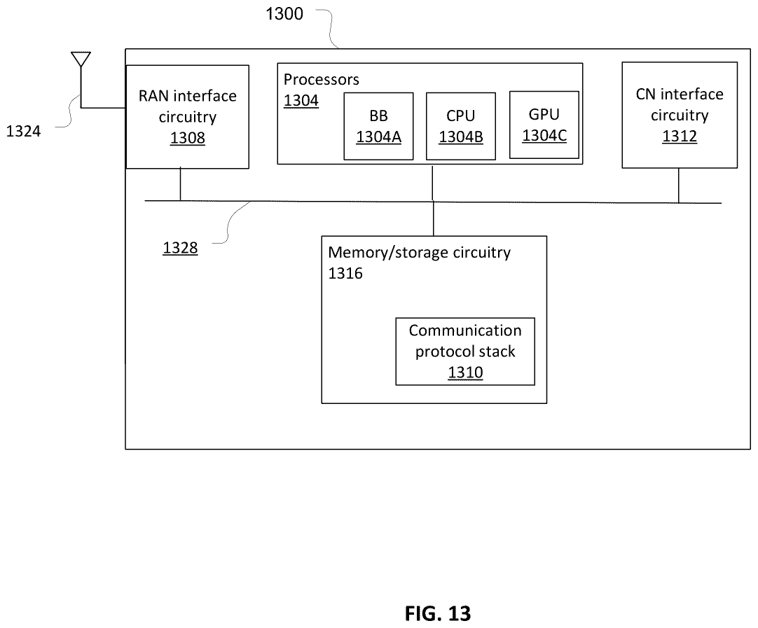

FIG. 13 illustrates a gNB 1300, in accordance with some embodiments. The gNB 1300 may include processors 1304, RF interface circuitry 1308, core network (CN) interface circuitry 1312, and memory/storage circuitry 1316.

The components of the gNB 1300 may be coupled with various other components over one or more interconnects 1328.

The processors 1304, RF interface circuitry 1308, memory/storage circuitry 1316 (including communication protocol stack 1310), antenna 1324, and interconnects 1328 may be similar to like-named elements shown and described with respect to FIG. 11.

The CN interface circuitry 1312 may provide connectivity to a core network, for example, a 5th Generation Core network (5GC) using a 5GC-compatible network interface protocol such as carrier Ethernet protocols, or some other suitable protocol. Network connectivity may be provided to/from the gNB 1300 via a fiber optic or wireless backhaul. The CN interface circuitry 1312 may include one or more dedicated processors or FPGAs to communicate using one or more of the aforementioned protocols. In some implementations, the CN interface circuitry 1312 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 includes a method of operating a user equipment (UE), the method comprising: transmitting, to a base station, an indication of a capability to measure a synchronization signal block (SSB) outside of an active bandwidth part (BWP);receiving, based on the transmission, a first configuration parameter for identifying a first BWP and a second BWP, a second configuration parameter for identifying the first BWP as an active BWP, and a third configuration parameter for identifying a frequency that is carrying the SSB; detecting the SSB in the second BWP and outside of the active BWP; and measuring the SSB.

Example 2 includes the method of example 1, wherein the capability to measure the SSB outside the active BWP is based on whether the UE conforms to a 3GPP release 18 standard, a 3GPP release 17 standard, or a 3GPP release 16 standard.

Example 3 includes the method of example 1 or 2, wherein the capability to measure the SSB outside the active BWP includes a respective indication for the capability per band, per band per band combination (BC), or per UE with frequency range differentiation.

Example 4 includes the method of examples 1-3, wherein the UE measures SSB for radio link monitoring (RLM), beam failure detection (BFD), layer 1 reference signal received power (L1-RSRP), or L1 signal to interference and noise ratio (L1-SINR), and wherein the UE reports a single capability to cover each of the RLM, BFD, L1-RSRP, and L1-SINR; or a first capability for measuring RLM and BFD measurements, a second capability for measuring L1-RSRP, and a third capability for measuring L1-SINR.

Example 5 includes the method of example 1-4, wherein measuring the SSB includes measuring a BFD at a special cell (SpCell) for the SSB outside the active BWP or measuring the BFD at a secondary cell for the SSB outside the active BWP.

Example 6 includes the method of examples 1-3 and 5, wherein the UE uses a channel measurement resource (CMR) for measuring L1-SINR of the SSB outside the active BWP.

Example 7 includes the method of examples 1-3, 5, and 6, wherein the UE is requested to transmit the indication of the capability to measure the SSB outside of the active BWP based on being configured to support the BWP without restriction, and wherein the UE is requested to transmit the indication of the capability to measure the SSB outside of the active BWP further based on whether the UE is capable of performing channel state information reference signal (CSI-RS) measurement of the RLM, CSI-RS measurement of a primary cell BFD, or CSI-RS measurement for L1-RSRP or L1-SINR.

Example 8 includes the method of examples 1-7, wherein the method further includes: restricting transmission of scheduled uplink (UL) transmissions and scheduled downlink transmissions at a beginning of the SSB; and releasing restriction of the transmission of the scheduled UL transmissions and downlink (DL) transmissions at an end of the SSB.

Example 9 incudes a method of operating a base station, the method comprising: receiving, from a user equipment (UE), an indication of a capability to measure a synchronization signal block (SSB) outside of an active bandwidth part (BWP); subdividing a channel bandwidth into a first BWP and a second BWP based on the indication; configuring the SSB based on the indication; and transmitting, based on the indication, a first configuration parameter for identifying the first BWP and the second BWP, a second configuration parameter identifying the first BWP as the active BWP, and a third configuration parameter identifying a frequency that is carrying the SSB.

Example 10 includes the method of example 9, wherein the method further includes configuring the SSB to be located in the second BWP of the downlink (DL) of a serving cell.

Example 11 includes the method of example 9 or 10, wherein the method further includes configuring the SSB as a cell defining SSB (CD-SSB).

Example 12 includes the method of examples 9-11, wherein the UE is a non-reduced capability user equipment (non-RedCap UE) and the SSB is a non-cell defining SSB (NCD-SSB).

Example 13 includes the method of examples 9-12, wherein the method further comprises configuring a single SSB for the first BWP and the second BWP.

Example 14 includes a method operating a non-reduced capability user equipment (non-RedCap UE), the method comprising: transmitting, to a base station, an indication of a capability to measure a non-cell defining synchronization signal block (NCD-SSB) outside of an active bandwidth part (BWP); receiving a first configuration parameter for subdividing an initial BWP into a first BWP and a second BWP, a second configuration parameter identifying the first BWP as an active BWP, and a third configuration parameter identifying a frequency that is carrying the NCD-SSB based on the transmission; and detecting the NCD-SSB in the second BWP and outside of the active BWP.

Example 15 includes the method of example 14, wherein the capability to measure the NCD-SSB outside the active BWP is based on whether the UE conforms to a 3GPP release 18 standard, a 3GPP release 17 standard, or a 3GPP release 16 standard.

Example 16 includes the method of example 14 or 15, wherein the capability to measure the NCD-SSB outside the active BWP includes a respective indication for the capability per band, per band and band combination, or per UE with frequency range differentiation.

Example 17 includes the method of examples 14-16, wherein a base station configures a cell defining SSB (CD-SSB) located at either the first BWP or the second BWP, and wherein the method further includes prioritizing the CD-SSB over the NCD-SSB.

Example 18 includes the method of example 14-17, wherein a base station configures a cell defining SSB (CD-SSB) located at either the first BWP or the second BWP, and wherein the method further includes prioritizing whichever of the CD-SSB or NCD-SSB is in the active band.

Example 19 includes the method of example 14-17, wherein a base station configures a cell defining SSB (CD-SSB) located at either the first BWP or the second BWP, and wherein the method further includes prioritizing one of the CD-SSB or NCD-SSB based on a respective periodicity of the CD-SSB or NCD-SSB.

Example 20 includes the method of example 14-16, wherein a base station configures a second SSB at the first BWP, and wherein the non-RedCap UE is configured to only measure the NCD-SSB.

Example 21 includes a method of operating a non-reduced capability user equipment (non-RedCap UE), the method comprising: transmitting, to a base station, an indication of a capability to measure a non-cell defining synchronization signal block (NCD-SSB) inside of an active bandwidth part (BWP); receiving a first configuration parameter for a first BWP, a second configuration parameter identifying the first BWP as an active BWP, and a third configuration parameter identifying a frequency that is carrying the NCD-SSB based on the transmission; and measuring the NCD-SSB in the first BWP and inside the active BWP.

Example 22 includes the method of example 21, wherein the capability to measure the NCD-SSB inside the active BWP is based on whether the UE conforms to a 3GPP release 18 standard, a 3GPP release 17 standard, or a 3GPP release 16 standard.

Example 23 includes the method of example 22 or 23, wherein the capability to measure the NCD-SSB inside the active BWP includes a respective indication for the capability per band, per band and band combination, or per UE with frequency range differentiation.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method performed by a user equipment (UE), the method comprising:
transmitting, to a base station, an indication of a capability to measure a synchronization signal block (SSB) outside of an active bandwidth part (BWP);
receiving, based on the transmission, a first configuration parameter for identifying a first BWP and a second BWP, a second configuration parameter for identifying the first BWP as an active BWP, and a third configuration parameter for identifying a frequency that is carrying the SSB;
detecting the SSB in the second BWP and outside of the active BWP; and
measuring the SSB in the second BWP and outside of the active BWP.

2. The method of claim 1, wherein the capability to measure the SSB outside the active BWP includes a respective indication for the capability per band, per band combination (BC), or per UE with frequency range differentiation.

3. The method of claim 2, measuring the SSB in the second BWP and outside of the active BWP includes:
measuring the SSB for radio link monitoring (RLM), beam failure detection (BFD), layer 1 (L1) reference signal received power (RSRP), or L1 signal to interference and noise ratio (SINK).

4. The method of claim 3 wherein transmitting the indication of the capability to measure a SSB outside of an active BWP includes:
transmitting the indication of the capability of the UE to measure the SSB for the RLM, BFD, L1-RSRP, and L1-SINR as a single capability.

5. The method of claim 3 wherein transmitting the indication of the capability to measure the SSB outside of the active BWP includes:
transmitting the indication of the capability of the UE to measure the SSB for the RLM, BFD, L1-RSRP, and L1-SINR as a first capability for measuring RLM and BFD, a second capability for measuring L1-RSRP, and a third capability for measuring L1-SINR.

6. The method of claim 1, wherein measuring the SSB in the second BWP and outside of the active BWP includes:
measuring a BFD at a special cell (SpCell) for the SSB outside the active BWP or measuring the BFD at a secondary cell for the SSB outside the active BWP.

7. The method of claim 1, wherein the UE uses a channel measurement resource (CMR) for measuring an L1-SINR of the SSB outside the active BWP.

8. The method of claim 1, wherein the method further includes:
receiving a request to transmit the indication of the capability to measure the SSB outside of the active BWP based on:
the UE being configured to support the BWP without restriction, and
UE being capable of performing channel state information reference signal (CSI-RS) measurement of RLM, CSI-RS measurement of a primary cell BFD, or CSI-RS measurement for L1-RSRP or L1-SINR.

9. The method of claim 1, wherein the method further includes:
restricting transmission of scheduled uplink (UL) transmissions and scheduled downlink transmissions at a beginning of the SSB in the second BWP and outside of the active BWP; and
releasing restriction of the transmission of the scheduled UL transmissions and downlink (DL) transmissions at an end of the SSB in the second BWP and outside of the active BWP.

10. A network node, comprising:
an interface; and
processing circuitry, coupled with the interface, the processing circuitry to:
receive, from a user equipment (UE), an indication of a capability to measure a synchronization signal block (SSB) outside of an active bandwidth part (BWP);
subdivide a channel bandwidth into a first BWP and a second BWP based on the indication;
configure the SSB based on the indication; and
transmit, based on the indication, a first configuration parameter for identifying the first BWP and the second BWP, a second configuration parameter identifying the first BWP as the active BWP, and a third configuration parameter identifying a frequency that is carrying the SSB.

11. The network node of claim 10, wherein processing circuitry further to:
configure the SSB to be located in the second BWP of a downlink (DL) transmission of a serving cell and outside the active BWP.

12. The network node of claim 10, wherein processing circuitry further to:
configure the SSB as a cell defining (CD) SSB.

13. The network node of claim 10, wherein the UE is a non-reduced capability user equipment (non-RedCap UE) and the SSB is a non-cell defining (NCD) SSB.

14. The network node of claim 10, wherein processing circuitry further to:
configure a single SSB for the first BWP and the second BWP.

15. One or more non-transitory, computer-readable media having stored thereon a sequence of instructions which, when executed by one or more processors, cause a non-reduced capability user equipment (non-RedCap UE) to:
transmit, to a base station, an indication of a capability to measure a non-cell defining (NCD) synchronization signal block (SSB) inside of an active bandwidth part (BWP);
receive a first configuration parameter for subdividing an initial BWP into a first BWP and a second BWP, a second configuration parameter identifying the first BWP as an active BWP, and a third configuration parameter identifying a frequency that is carrying the NCD-SSB based on the transmission; and
perform a measurement on the NCD-SSB in the first BWP and inside of the active BWP.

16. The one or more non-transitory, computer-readable media of claim 15, wherein the capability to measure the NCD-SSB inside the active BWP includes a respective indication for the capability per band, per band and band combination, or per UE with frequency range differentiation.

17. The one or more non-transitory, computer-readable media of claim 15, wherein a base station configures a cell defining (CD) SSB located at either the first BWP or the second BWP, and wherein the instructions which, when executed by one or more processors, cause the non-RedCap UE further to:
prioritize the CD-SSB over the NCD-SSB.

18. The one or more non-transitory, computer-readable media of claim 15, wherein a base station configures a cell defining SSB (CD-SSB) located at either the first BWP or the second BWP, and wherein the instructions which, when executed by one or more processors, cause the non-RedCap UE further to:
prioritize whichever of the CD-SSB or NCD-SSB is in the active band.

19. The one or more non-transitory, computer-readable media of claim 15, wherein a base station configures a cell defining (CD) SSB located at either the first BWP or the second BWP, and wherein the instructions which, when executed by one or more processors, cause the non-RedCap UE further to:
prioritize one of the CD-SSB or NCD-SSB based on a respective periodicity of the CD-SSB or NCD-SSB.

20. The one or more non-transitory, computer-readable media of claim 15, wherein a base station configures a second SSB at the first BWP, and wherein the non-RedCap UE is configured to only measure the NCD-SSB.
